(19) United States
(12) Patent Application Publication
(10) Pub. No.: US 2006/0149848 A1
(43) Pub. Date: Jul. 6, 2006

(54) System, apparatuses, and method for linking and advising of network events related to resource access

(75) Inventor: A. David Shay, Lawrenceville, GA (US)

Correspondence Address: SMITH FROHWEIN TEMPEL GREENLEE BLAHA, LLC, P.O. BOX 88148, ATLANTA, GA, 30356, US

(73) Assignee: Trusted Network Technologies, Inc., Alpharetta, GA (US)

(21) Appl. No.: 11/311,018

(22) Filed: Dec. 19, 2005

Related U.S. Application Data
(60) Provisional application No. 60/641,845, filed on Jan. 4, 2005.

(51) Int. Cl. G06F 15/16

(52) U.S. Cl. 709/229

(57) ABSTRACT

The disclosed system, apparatuses, and method can be used to relate network event data generated by different devices in a computer network in order to provide a user with a comprehensive view or report of network activity occurring on a computer network, including the computer, user, network address, and resource involved. This comprehensive view of network activity can be used to prove compliance with applicable policy, law and/or regulation restricting access to a resource such as confidential business information and/or personal information required to be protected. In addition, the comprehensive view of network activity can be used to discover vulnerabilities in the computer network, to monitor ongoing network activity, and to enforce applicable security policy, law and/or regulation to prevent access to a network resource.

### CROSS-REFERENCE TO RELATED APPLICATIONS

This patent application is a U.S. nonprovisional application filed pursuant to Title 35, United States Code §100 et seq. and 37 C.F.R. Section 1.53(b) claiming priority under Title 35, United States Code §119(e) to U.S. provisional application No. 60/641,845 filed Jan. 4, 2004 naming A. David Shay as the inventor, which application is herein incorporated by reference. Both the subject application and its provisional application have been or are under obligation to be assigned to the same entity.

### BACKGROUND OF THE INVENTION

This invention relates to a system, apparatuses, and method for linking and processing network event data for use for a variety of purposes, including demonstrating compliance with applicable policies, laws and regulations regarding access of network resources, monitoring network activity related to access of network resources, discovering vulnerabilities or issues with an organization's network security, and/or enforcing network resource access policies to prevent access to protected resources to entities not permitted access.

Organizations commonly use computer networks to enable their workers to access network resources such as applications and data which are required to perform their job responsibilities. Even an organization of moderate size can have a vast array of hardware, software, and data resources on its network, as well as users that have differing privileges to access the network resources. Moreover, the hardware, software, and users of the organization computer network can be geographically distributed, and/or can be comprised of different local area networks (LANs) or nodes that are connected together, such as in a virtual private network (VPN) or wide area network (WAN), for example. Due to these complications, managing a computer network and hosted resources for an organization of even modest size is generally a very difficult task.

Nonetheless, controlling access to network resources is a paramount concern of virtually all organizations. Certain resources, such as business information including confidential information and trade secrets and other competitive data, accounting and financial data, vendor or supplier data, or personal information of customers or others acquired by the organization in its operations, should be made available on the computer network only to those who need to know and are privileged to access such information. Organizations are acutely aware that failure to adequately guard such information can result in loss of competitive advantage, loss of good will, or even civil or criminal liability for failure to comply with applicable privacy laws and the like.

For example, in many countries throughout the world, certain kinds of information (e.g., a consumer's private information) must be protected by the organization. In the United States, the Health Insurance Portability and Accountability Act (HIPAA) of 1996 requires covered organizations to maintain electronic health information protected under the Act to permit access only to those persons or software programs that have been granted access rights as provided by applicable regulations. Similarly, Section 404 of the Sarbanes-Oxley Act requires the management of an organization to state the responsibility of management for establishing and maintaining an adequate internal control structure and procedures for financial reporting, and also to contain an assessment of the effectiveness of the internal control structure and procedures of the organization for financial reporting. Thus, controlling who has access to resources on a computer network and being able to prove compliance with applicable laws and regulations has become a major concern of organizations in modern business environments.

There is therefore a need for a system, apparatuses, and method that can be used to provide proof of who has been accessing what resources on the computer network. Although various accounting and billing software is available to track costs associated with network activity and assign such cost to users, from the standpoint of controlling access to network resources, there is believed to be no system, apparatuses, or method that can be used to readily verify who has accessed what network resources over a given period of time to provide a record of compliance in connection with audits of resource access on a computer network. Moreover, it would be desirable if a system, apparatuses, and method could be implemented to provide a comprehensive view enabling a network administrator to identify security vulnerabilities or issues in a computer network, to enforce network security policy to prevent access to resources to those who are not permitted access under applicable security policies, and to monitor access to network resources and thus ensure their security. Instead of providing these benefits, current technologies are focused on information technology (IT)-centric views of packet flows and the like, which, although useful for some purposes, are too focused on narrow classes of information that do not provide the comprehensive view needed to ensure the security of network resources. With the consequences for failing to comply with security policy being so severe, there has been a longstanding need for an invention that provides a comprehensive understanding of network activity and related parameters from a security perspective.

### BRIEF SUMMARY OF THE INVENTION

The disclosed invention, in its various embodiments, overcomes one or more of the above-mentioned problems, and achieves additional benefits and advantages as hereinafter described.

A method according to one embodiment of the invention comprises a step of receiving assignment event data from a first device on a computer network, the assignment event data comprising a computer address of a user computer and a network address assigned to the user computer for use in a session on a computer network. The method further comprises receiving authentication event data from a second device on the computer network, the authentication event data indicating the user of the user computer has been authenticated to the computer network for the session and the network address assigned to the user computer used by the user. The method further comprises receiving resource access event data from a third device on the computer network, the resource event data indicating the network address of the user computer and resource accessed by the user computer during the session. The method further comprises linking the assignment event data, authentication event data, and resource access event data using the network address common to such event data. Furthermore, the method comprises the steps of generating presentation data for rendering a presentation, based on the linked assignment event data, authentication event data, and resource access event data; and generating a presentation based on the presentation data.

In the exemplary embodiment of this method, the first device can be a dynamic host configuration protocol (DHCP) server that assigns the network address from a pool to the user computer for use during the session. The second device can be a directory server storing a directory of user identification data to authenticate the user by checking user identification data provided by the user against the user identification data in the directory to determine whether the user identification data provided by the user is valid. The third device can be a network sensor unit which detects resource access event data. The network sensor unit can be strategically positioned within the computer network in front of one or more resource servers or computers to detect all requests to access a resource hosted by such server. Where resource servers are distributed, whether in a single location or in multiple locations which may be geographically dispersed, multiple network sensors can be used to detect resource access requests to such servers. In the method the network sensor can extract at least part of the resource access event data (e.g., the IP address and port number indicating the resource or application to which access is sought) from a packet transmitted by the user computer to a resource server to request access to the resource via the computer network. The receiving of the event data can be performed by a collector which receives and consolidates event data generated by multiple, possibly all, sensors on the computer network. The collector can store the received event data in a data storage unit. Moreover, before or after storing the event data, the collector can link different event data to a respective session by using the network address common to such event data, and optionally also temporal proximity thereof indicated by timestamps associated with such data. In addition, the collector can compact the event data so linked by eliminating redundant elements of data common to two or more of the linked event data. Alternatively, the advisor can perform some or all of the linking of the event data. The advisor can perform the generation of presentation data and rendering of a presentation in response to user indication data indicating a particular presentation and associated parameters desired by the user to be generated by the advisor. The advisor can generate the presentation to indicate by session the assignment event data, authentication event data, and resource access event data, optionally linked, including the computer address, network address, and user identification data associated with each session. This can be used to provide a comprehensive view or understanding of what users have had and/or sought access to which resources using which computers on the computer network. The advisor can generate the presentation to indicate timestamps associated with respective assignment event data, authentication event data, and resource access event data. Furthermore, the advisor can generate the presentation to indicate whether any assignment event data and authentication event data are missing from a session, thus indicating a possible attack on the computer network has occurred or is underway. The advisor can receive the event data and generate the presentation on a real-time basis so as to detect any attack while the attack is still underway, permitting action to be taken to stop the attack. The advisor can generate an alert signal to indicate to a network administrator that a session has missing assignment event data and/or authentication even data, thus indicating an attack. Moreover, the advisor can generate an alert signal to advise an enforcement device on the computer network to prevent access to a network resource to a user, computer, and/or network address associated with a session having missing assignment event data and/or authentication even data. The enforcement device can be the first, second, and/or third device described above, for example.

A system according to an embodiment of the invention comprises a first server, second server, one or more network sensor units, a collector, data storage unit, and an advisor. The first server maintains a network address pool, and is configured to assign network addresses to respective user computers for corresponding sessions on a computer network. The first server is further configured to generate assignment event data indicating the network address assigned to a user computer for use in a respective session on the computer network, and the computer address of the user computer to which the network address was assigned. The second server has a directory of user identification data, and is configured to be used to authenticate users by comparing user identification data provided by users, with user identification data stored in the directory, in order to determine whether the user identification data provided by users are valid. The second server can generate an authentication event data indicating the network address assigned to a user computer, and the user identification data determined to be valid for the user for a respective session. One or more network sensor units are coupled in the computer network in proximity to a corresponding network device storing at least one network resource. The network sensor detects requests to access one or more network resources, and generates resource access event data in response to a request to access the network resource from a user computer. The resource access event data comprises the network address assigned to the user computer and data indicating the resource to which access is requested. The collector is coupled to the computer network to receive assignment event data, authentication event data, and resource access event data from the first server, second server, and network sensor unit. The data storage unit is coupled to the collector and stores the assignment event data, authentication event data, and resource access event data received from the collector. The advisor is coupled to at least one of the collector and data storage unit, receives the assignment event data, authentication event data, and resource access event data, and generates a presentation based on the assignment event data, authentication event data, and resource access event data.

The system according to this embodiment can be implemented so that the first server comprises a dynamic host configuration protocol (DHCP) server which assigns internet protocol (IP) addresses as network addresses. The directory of the second server can be implemented as part of Active Directory® service/software commercially available from Microsoft Corporation. The second server can use lightweight directory access protocol (LDAP). The network sensor unit can detect a transport control protocol (TCP) SYN packet transmitted by the user computer to open a network connection with a resource computer on the computer network, and can extract at least part of the resource access event data from the SYN packet. Because the SYN packet is the first packet to be transmitted when a user computer seeks to open a connection with a resource server, and it includes data indicating the network address and resource (e.g., port) sought to be accessed, the SYN packet provides an effective way to detect a request to access a resource on the computer network. The collector can be configured to link the network address assignment event data, authentication event data, and resource access event through the network address common to such event data. In addition, the assignment event data, authentication event data, and resource access event data can be further linked by temporal proximity of timestamps associated with such event data. The assignment event data, authentication event data, and resource access event data can be linked by the advisor through the assigned network address (which can be, e.g., an internet protocol (IP) address) common to such event data. The assignment event data, authentication event data, and resource access event data can be further linked by temporal proximity of timestamps associated with such event data. The advisor can generate a presentation indicating assignment event data, authentication data, and resource access event data, including the computer address, user identification data, and network address associated with each session. The advisor can generate the presentation by applying rule data corresponding to user indication data identifying the type of presentation a network administrator desires to receive, to the event data received by the advisor. The advisor can further generate the presentation to indicate whether any assignment event data and authentication event data are missing from a session, thus indicating a possible attack on the computer network. The advisor can generate the presentation on a real-time basis to detect an attack while the attack is still underway. The advisor can apply rule data to the event data to determine whether to generate an alert signal in the presentation. The rule data can define one or more of missing network address assignment event data, missing authentication event data, and missing resource access event data for a user session as rules triggering generation of the alert signal. The advisor can further generate a blocking signal to advise an enforcement device on the computer network to prevent access to a network resource for a user, computer and/or network address associated with a session if the session is determined to have missing assignment event data, authentication event data, and/or resource access event data. The enforcement device can be the first and second servers, a network device hosting a resource, or a network switch, for example. The advisor can link the event data and compact the event data by eliminating redundant data for each session. Furthermore, the advisor can generate a presentation including a listing of event data for sessions over a time period. The time period can be specified by a person such as a network administrator as user indication data input to the advisor to indicate the time period over which the listing is to be generated in the presentation. The system thus has utility in proving compliance with policies, laws and/or regulations affecting access to network resources on an organization's computer network.

An apparatus according to one embodiment of the invention comprises a collector configured to receive assignment event data indicating network addresses assigned to respective user computers for sessions on a computer network and the computer address of the user computer, authentication event data indicating the network address of the user computer and user identification data indicating the users of respective user computers, and resource access event data indicating access of network resources by user computers via the computer network. The collector stores the received assignment event data, authentication event data, and resource access event data in a data storage unit. The collector can be configured to link assignment event data, authentication event data, and resource access event data using the network address common to such event data. The collector can be further configured to link the assignment event data, authentication event data, and resource access event data using temporal proximity of timestamp data associated with such event data. The collector can be configured to transmit the event data to an advisor for use in generating a presentation based on such event data. The collector can be configured to compact related or linked event data to eliminate redundant elements for one or more user sessions, and to store the event data in compacted form in the data storage unit.

An apparatus according to a second embodiment comprises an advisor configured to receive assignment event data indicating network addresses assigned to respective user computers for sessions on a computer network and the computer address of the user computer, authentication event data indicating the network address of the user computer and user identification data indicating the users of respective user computers, and resource access event data indicating access of network resources by user computers via the computer network. The advisor generates a presentation based on the received assignment event data, authentication event data, and resource access event data. The advisor can be configured to link assignment event data, authentication event data, and resource access event data using the network address common to such event data. The advisor can be further configured to link the assignment event data, authentication event data, and resource access event data using temporal proximity of timestamp data associated with such event data. The advisor can be further configured to generate the presentation to indicate assignment event data, authentication data, and resource access event data, including the network address, computer address, and user identification data, thus providing a user such as a network administrator with a comprehensive view and understanding of network activity occurring on the network from a resource security perspective. The advisor can be further configured to generate the presentation to indicate whether any assignment event data, authentication event data, and/or resource access event data are missing from a session, thus indicating a possible attack on the computer network. The advisor can generate the presentation on a real-time basis as the event data are received to detect an attack while an attack is still underway. The advisor can generate the presentation to include an alert signal to indicate to a user such as a network administrator that an attack is underway. The advisor can generate a blocking signal to advise an enforcement device on the computer network to block access to a network resource for a user, computer and/or network address associated with a session having missing assignment event data, authentication event data, and/or resource access event data.

### BRIEF DESCRIPTION OF THE SEVERAL VIEWS OF THE DRAWING

Having thus described the invention in general terms, reference will now be made to the accompanying drawings, which are not necessarily drawn to scale, and wherein:

FIG. 1 is a block diagram of a computer network system according to an exemplary embodiment of the invention.

FIG. 2A is a block diagram of a network address server used to assign network addresses to user computers on the computer network for use in sessions.

FIG. 2B is a flowchart of a method for reporting event data regarding assignment of a network address to a computer, to a collector for collection and storage.

FIG. 3A is a block diagram of a directory server for maintaining a directory of entities such as users, computers, resources, and the like on a computer network.

FIG. 3B is a flowchart of a method for reporting authentication event data to a collector for collection and storage.

FIG. 4A is a block diagram of a network sensor for sensing network events related to access of a resource hosted on the computer network.

FIG. 4B is a method for reporting resource access event data sensed by a network sensor for transmission to the collector for collection and storage.

FIG. 5A is a block diagram of a collector configured to receive event data related to network address assignment, user authentication, and resource access, and optionally to store such event data in a data storage unit and link such event data by network address and timestamp.

FIG. 5B is a flowchart of a method for receiving and linking event data received from network sensors for network address assignment, authentication, and resource access events.

FIG. 5C is a schematic view of the manner of linking a computer address, network address, user identification data, and resource accessed based on the event data for the network address assignment, authentication, and resource access events.

FIG. 6A is a block diagram of a data storage unit for storing event data related network address assignment, authentication, and resource access events, optionally in linked form.

FIG. 6B is a flowchart of a method for storing event data related to network address assignment, authentication, and resource access events, optionally in linked form.

FIG. 7A is a block diagram of an advisor for generating a presentation and/or alert signal based on the event data related to assignment of a network address, authentication of a user, and resource access.

FIG. 7B is a flowchart of a method for generating a presentation and/or alert signal based on the event data related to assignment of a network address, authentication of a user, and resource access.

FIG. 8 is a view of a presentation generated by the advisor in accordance with an embodiment of the invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### DEFINITIONS

‘And/or’ means ‘one, some, or all’ of the things immediately preceding and succeeding this phrase. Thus, ‘A, B and/or C’ means ‘any one, some or all of A, B, and C.’

‘Computer’ broadly refers to any kind of device which receives input data, processes that data under programmed instructions, and generates output data such as a presentation or alert signal. Such computer can be a hand-held device, laptop computer, desktop computer, miniframe, mainframe, server, or other computer, for example. A ‘computer’ generally includes a processor and a memory, and input and output units with an interface unit enabling connection to other computers or devices.

‘Connected’ or ‘coupled’ refer to a physical connection between two computers permitting communication of data. Two devices can be connected directly together or indirectly through one or more intermediate elements, to permit communication of data/signal from one device to the other. Connection media include wire, optical fiber, or wireless transmission media such as air or space, permitting communication of data or a signal.

‘Data storage unit’ is any device capable of storing data, including random-access memory (RAM), read-only memory (ROM), electrically-erasable read-only memory (EEPROM), hard disk and disk drives, compact disc (CD), digital versatile disc (DVD), magnetic tapes and tape drives, optical storage media, quantum memory devices, and any other device that can be used to store data in readable form.

‘Input unit’ can be a keyboard, keypad, mouse, wand, stylus, voice receiver, or any other device capable of receiving input data from a human user.

‘Interface Unit’ can be a network interface card (NIC), a modem, or other interface device.

‘Memory’ can be any device capable of storing data, including random-access memory (RAM), read-only memory (ROM), electrically-erasable read-only memory (EEPROM), hard disk and disk drives, compact disc (CD), digital versatile disc (DVD), magnetic tapes and tape drives, optical storage media, quantum memory devices, and any other device that can be used to store data in readable form.

‘Output unit’ can be a display monitor (e.g., CRT or flat panel display), speaker, vibration unit, or any other device that can be used in a computer to generate a humanly perceptible presentation.

‘Presentation’ is any form of humanly perceptible information, including a visual display, sonic signal, or tactile signal, for example, and may be rendered or generated by a computer.

‘Processor’ can be any device capable of receiving, processing, and outputting data under programmed instructions, including a microprocessor, microcontroller, programmable gate array (PGA), field programmable gate array (FPGA), programmed array logic (PAL), programmable logic array (PLA), or other such device.

‘Server’ is a computer. The term can have a more refined meaning as a computer that executes a server application responsive to computers executing client applications or the like, i.e., client-server architectures.

‘(s)’ or ‘(ies)’ means one or more of the thing meant by the word immediately preceding the phrase ‘(s)’. Thus, “resource(s)” means “one or more resources.”

System

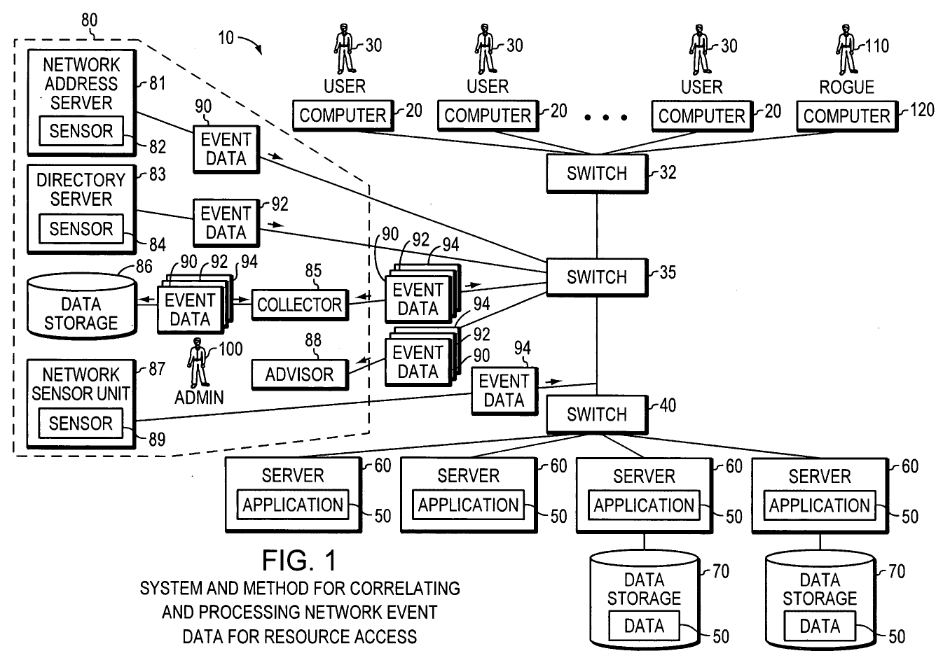

FIG. 1 is an exemplary Computer Network 10 of an organization. Although FIG. 1 is a simplification of the Computer Network of a typical organization, it will serve to demonstrate the basic structure and functionality of the claimed System. The Computer Network 10 comprises Computers 20 operated by respective Users 30 who are generally workers within the organization, or persons in some way affiliated with the organization, such as vendors, suppliers, customers, etc. The Computers 20 can be desktop, laptop, or hand-held devices such as personal digital assistants, pagers, cellular telephones, web browsers, or other devices. Whether connected to the network by conductive wires, optical fiber, or wireless transmission media, the Computers 20 communicate with one or more Switches 30 in corresponding offices or locations within the organization. The Switch 32 is connected to Switch 35 which, in turn, is connected to Resource Switch 40 to provide the Users 30 with access to Network Resources 50 via Connected Servers 60. The Network Resources 50 can be applications and/or data stored in Data Storage Units 70, as shown in FIG. 1.

The Computer Network 10 comprises a System 80 which comprises a Network Address Server 81 with Sensor 82, a Directory Server 83 with Sensor 84, a Collector 85 with Connected Data Storage Unit 86, a Network Sensor Unit 87 with Sensor 89, and an Advisor 88, all connected to the Switch 35. Again, this configuration is exemplary only, and the specific manner in which such elements can be connected together is generally unlimited, as is appreciated by those skilled in the art.

The Network Address Server 81 can be implemented as a Dynamic Host Configuration Protocol (DHCP) server which maintains a pool of network addresses to be assigned to Computers 20 when a User 30 initiates a session on the Computer Network 10. More specifically, when a User 30 operates a Computer 20 to establish a connection with the Computer Network 10, the Network Address Server 81 assigns the network address (e.g., an Internet Protocol (IP) address) to the requesting computer for use in the session thus initiated by the user. In this process, the Network Address Server 81 receives from the Computer 20 the computer address hardwired into such Computer. For example, the computer address of the Computer 20 can be a machine or Media Access Control (MAC) address fixed in the computer's hardware (e.g., its network interface card or NIC). The computer address uniquely identifies such Computer 20. The Sensor 82 of the Network Address Server 81 generates Network Address Assignment Event Data 90 which relates the computer address of the Computer 20 to the network address assigned to that Computer by the Network Address Server 81 for use in the session. In addition to the computer address and assigned network address, the Event Data 90 can include the time at which the Network Address Server 81 assigned the network address to the Requesting Computer 20, the lease time permitted to the Computer 20 to use the assigned network address, and an identifier assigned by the Network Address Server to uniquely identify the Event Data 90. The Event Data 90 for the network address assignment event can thus be a data string or linked set of data having the following form:

MAC address of requesting computer—IP address assigned to requesting computer—time of assignment of IP address to requesting computer—time of lease of the assigned IP address—DHCP identifier assigned by DHCP server to the assignment event.

The Sensor 82 is configured to detect that Event Data 90 is ready for transmission to the Collector 85 for storage. It can do this by checking a log file storing the Event Data 90 periodically, or may simply periodically send unreported Event Data 90 to the Collector 85. The Collector 85 receives the Event Data 90 transmitted by the Sensor 82 via the Switch 35, and stores this Event Data in the Data Storage Unit 86.

The next action normally undertaken during a session by the User 30 via Computer 20 is to authenticate himself/herself to the Computer Network 20. Under prompting by the Directory Server 83 (or other device charged with authenticating users using the Directory Server), the Computer 20 prompts the User 30 to input his/her user identification data, which can be a username or ‘login-id’, and the input data is transmitted via Switches 30 and 35 to the Directory Server 83. The Directory Server 83 can be implemented using Active Directory® (AD) technology of Microsoft Corporation, Redmond, Wash., and/or Lightweight Directory Access Protocol (LDAP), for example. The Directory Server 83 compares the user identification data against its directory to verify that the user identification provided by the user is present in the directory and thus is valid. Assuming that the user identification data is valid, the Directory Server 83 authenticates the User 30 to the Computer Network 10 so that the user can have access to the network resources permitted such User by the privileges and rules defined for such User in the Directory Server 83. The Directory Server 83 generates Authentication Event Data 92 indicating the IP address originating the authentication request, the time at which the user was authenticated to the Computer Network 10, the Active Directory® identifier associated with the authentication event, the fully qualified domain name (FQDN) from which the authentication request originated (e.g., in the form www.someorganization.com), the group to which the User 30 has been assigned (the user generally has the network resource access privileges assigned to the group), and the user identification data provided by the user. Thus, the authentication event data can be a data string with the following structure:

IP address assigned to user computer—time of authentication of user—active directory (ADM) identifier—Fully Qualified Domain Name (FQDN)—group to which the user is assigned—log-in ID of the user.

The generation of the Authentication Event Data 92 can trigger the Sensor 84 to transmit such event data to the Collector 35 via the Switch 35, or the Sensor 84 may transmit the Event Data 92 periodically in batches to the Collector 85. The Collector 85 stores the Event Data 92 in the Data Storage Unit 86.

Next, the User 30 requests access to a resource on the Computer Network 10. In this process, the User 30 operates the Computer 20 to generate a packet requesting access to the Resource 50. This packet can be a transfer control protocol (TCP) SYN packet which initiates a SYN-SYNACK-ACK packet exchange or handshake to open a network connection between the User Computer 20 and a Resource Server 60. Such request packet includes not only the network address of the destination Resource Server, but also the network address assigned to the User Computer 20 by the Network Address Server 81 at the beginning of the session on the Computer Network 10. In addition, such request packet further comprises a port number which identifies the Resource 50 for which access is requested. For example, a port number of ‘25’ indicates an SMTP application is the requested resource, a port number ‘80’ indicates an HTTP application is requested, etc. When the packet requesting access to the Resource 50 traverses the Switches 30, 35, 40 to the Target Resource 50 hosted by a Server 60, the Network Sensor Unit 87 detects the request to access the resource and generates Event Data 94 including the time of detection of the resource request, the network address assigned to the Computer 20 requesting access to the Resource 50 for the session, the computer address of the Computer 20 originating request to access the target Resource 50, the destination network address of the Server 60 hosting the Resource 50, identification of the specific Resource 50, i.e., application, sought by the resource request, and other data such as the number of bytes in the request, the number of packets in the request, and the transmission length of the request. Thus, the Resource Access Event Data 94 can be a data string having the following form:

Time of request—IP address of originating computer—MAC address of originating computer—destination address for request—application sought by request (e.g., port number)—number of bytes transmitted with request—number of packets constituting request—transmission length of request.

The Network Sensor Unit 87 reports the Resource Access Event Data 94 to the Collector 85 via Switch 35 in real-time or periodically after accumulation on a batch basis, and the Collector stores such event data in the Data Storage Unit 86.

The above operations are repeated each time a User operates a Computer to initiate a session with the Computer Network 10. Thus, the Collector 85 receives and stores Event Data 90, 92, 94 for numerous requests generated on the Computer Network 10 over time.

The Advisor 88 is connected to the Collector 85 and the Data Storage Unit 86 via the Switch 35. The Advisor 88 can access the Event Data 90, 92, 94 stored in the Data Storage Unit 86 and uses this event data to generate presentations useful for Network Administrator 100 for one or more of a variety of purposes. For example, the Administrator 100 can operate the Advisor 88 to generate a textual and/or graphical presentation to verify compliance with applicable resource access policies, laws, and regulations. For example, when a User 30 initiates a session with the Computer Network 10, a series of Event Data 90, 92, 94 should under normal circumstances be present in the Data Storage Unit 86 for each session. If one or more of the Event Data 90, 92, 94 are missing in the recorded data for a session, it is possible that security of a network resource has been compromised. For example, a rogue 110 may have used the IP address already assigned by the Network Address Server 81 to another User in order to access a Network Resource 50. Or a Computer 120 or alien device may have been connected in the Computer Network 10 by a rogue or contractor of the organization, for example, in such a way as to bypass the Directory Server 83. As another possible scenario, the Network Sensor Unit 87 may have been disabled, or a rogue connected in Alien Computer 120 to an Application Server 60 in such a way as to bypass the Network Sensor 87. Conversely, if for each user session, corresponding Event Data 90, 92, 94 is stored in the Data Storage Unit 86 and are linked by common data elements and/or time of the recorded event to indicate reasonable correspondence, then compliance with applicable resource access policy, law or regulation can be readily demonstrated. The Advisor 88 can render a report based on such Event Data 90, 92, 94 to prove compliance with resource access policy, law, and regulation applicable for the resource required to be protected on the Computer Network 10.

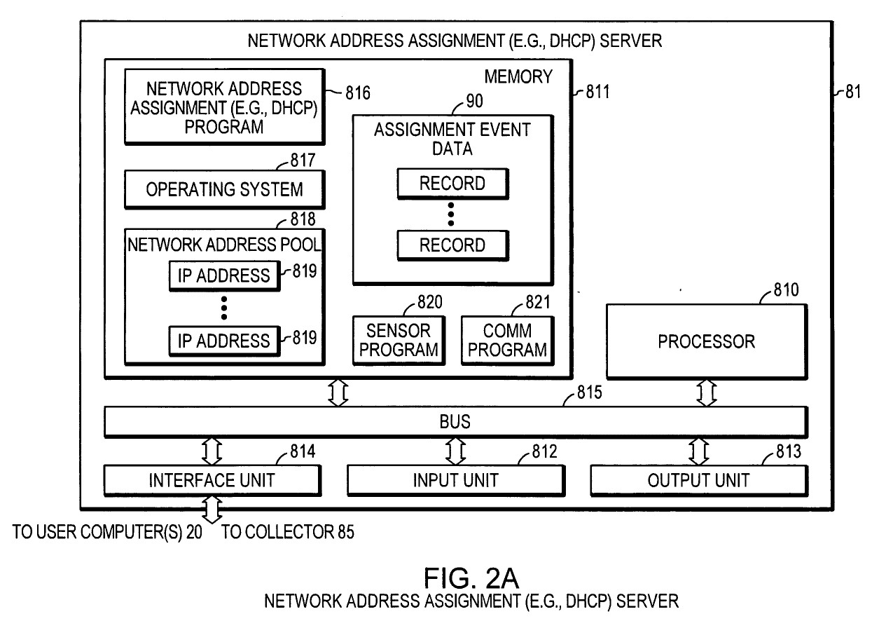

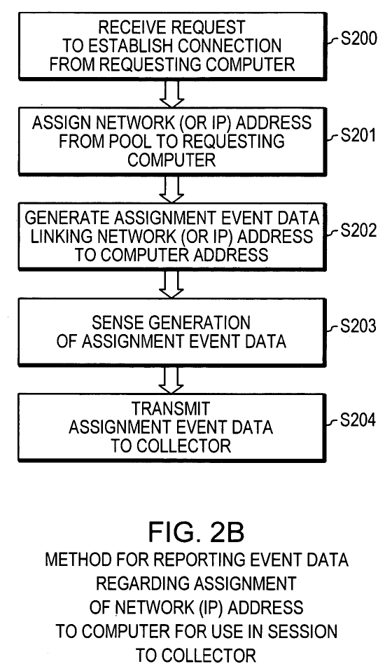

FIG. 2A is an exemplary Network Address Server 81 which comprises a Processor 810, a Memory 811, an Input Unit 812, an Output Unit 813, an Interface Unit 814, and a Bus 815 coupling these elements together. The Processor 810 executes the Network Address Assignment Program 816 in the Operating System 817 in order to perform its functions. Specifically, the Processor 810 executes the Network Address Assignment Program 816 and the Operating System 817 to assign network addresses from its Pool 818 to Computers 20 initiating a session with the Computer Network 10. As the Processor 10 assigns each Network Address 819 to a User Computer 20, the Processor 810 generates the Assignment Event Data 90 including the data previously mentioned. The Processor 810 executes the Sensor Program 820 to report the Assignment Event Data 90 to the Collector 85 for storage in the Data Storage Unit 86. This can be done on a real-time or batch basis, as previously explained. The Processor 810 further executes the Communication Program 821 in order to enable it to communicate the Event Data 90 to the Collector 85. The Communication Program 821 can be, for example, a Transfer Control Protocol/Internet protocol (TCP/IP) stack. The Processor 810 can receive the request to initiate a session from a User Computer 20, and transmit Event Data 90 to the Collector 85 via the Bus 815 and Interface Unit 814. The Interface Unit 814 can be a Network Interface Card (NIC) or modem, for example. The Input Unit 812 and the Output Unit 813 enables a Network Administrator 100 to interact with the Network Address Server 81 for installation and maintenance of its hardware and software, for example.

FIG. 2B is a method for reporting event data related to assignment of a network address to a User Computer 30 for use in a session. This method can be executed by the Processor 810 of the Network Address Server 81 to report Network Address Assignment Event Data 90 to the Collector 85. In Step S200, a request to establish a network connection with the Computer Network 10 is received from requesting Computer 20. In Step S201, a network (e.g., IP) address from a network address pool is assigned to the requesting computer 30. In Step S202, Event Data 90 linking the assigned network address to the computer (e.g., MAC) address is generated. In Step S203, the Assignment Event Data 90 is generated. This step can be performed by the Processor 810 as it executes the Sensor Program 820. In Step S204 the Assignment Event Data 90 is transmitted to the Collector 85.

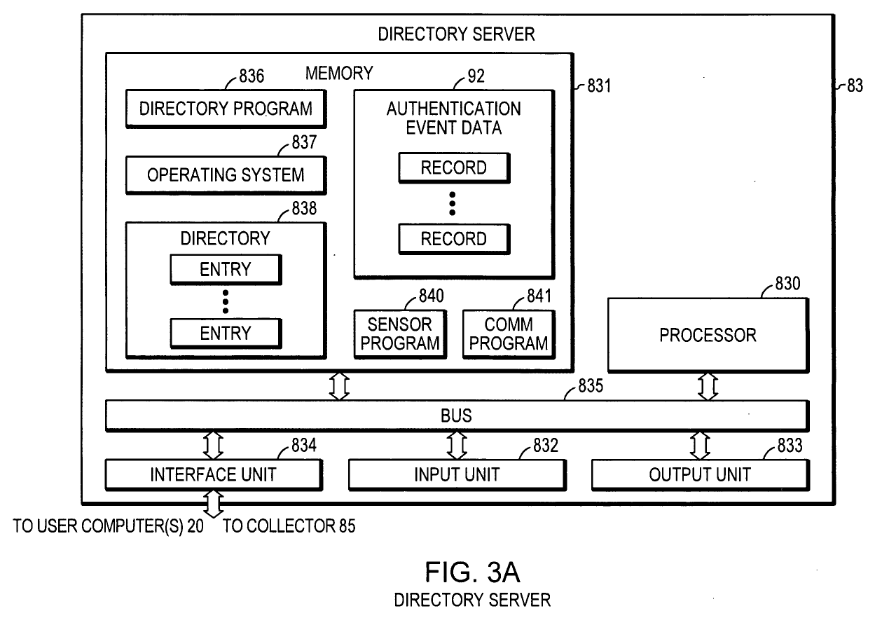

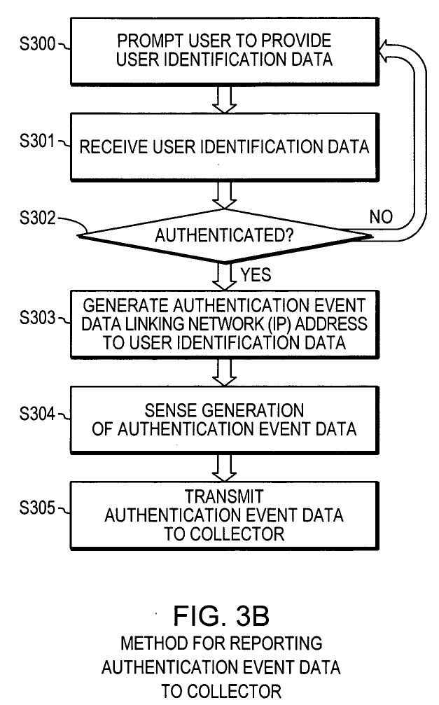

FIG. 3A is an exemplary embodiment of the Directory Server 83. The Directory Server 83 comprises a Processor 830, a Memory 831, an Input Unit 832, an Output Unit 833, an Interface Unit 834, and a Bus 835 connecting these elements together. The Processor 830 executes the Directory Program 836 and the Operating System 837 in order to perform its functions. In addition, the Memory 831 stores Directory 838 which contains entries regarding network-based entities of the computer network 10, such as resources (e.g., applications), files, printers, and users with corresponding user identification data. The Directory 838 provides a consistent way to name, describe, locate, access, manage, and secure information regarding network resources. Further the Directory 838 manages the identities and brokers relationships between distributed entities to enable the same to work together. Directory 838 can be the Active Directory® service/software commercially available from Microsoft Corporation, Redmond, Wash. The Processor 830 uses the Directory 838 to authenticate the User 30 requesting initiation of a session by verifying that the user identification data provided by such user to the Directory Server 83, corresponds with user identification data in the Directory 838 and thus corresponds to a user that is registered in the Directory 838. If the user identification data is determined by the Directory Server 83 to be valid by presence in the Directory 838, the Processor 830 generates Authentication Event Data 92 including a record or data to indicate the fact that the User 30 has been authenticated to the Computer Network 10. Alternatively, if the User 30 fails to provide valid user identification data, the Processor 830 can as well store the data indicating this fact as Authentication Event Data 92. The Processor 830 executes the Sensor Program 840 to sense generation of Authentication Event Data 92 to be transmitted to the Collector 85. The Processor 830 further executes the Communication Program (e.g., a TCP/IP stack) 841 to encapsulate and transmit the Authentication Event Data 92 to the Collector 85 for storage in the Data Storage Unit 86. The Processor 830 transmits the Authentication Event Data 92 via the Interface Unit 834 (which can be a NIC card or modem, for example) and the Bus 835.

FIG. 3B is a method for reporting Authentication Event Data 92 to the Collector 85. The method of FIG. 3B can be carried out by the Directory Server 83, or more specifically, the Processor 830 thereof. In Step S300, the User 30 is prompted to provide user identification data. In Step S301, the user identification data entered by the User 830 is received. In Step S302, the determination is made to establish whether the User 30 can be authenticated to the Computer Network 10 on the basis of the user identification data provided. If not, the method returns to Step S300 to repeat the prompting of the User 20 to provide correct user identification data. Conversely, if the user identification data provided by the User 30 matches an entry in the Directory 838 for the Computer Network 10, the Directory Server 83 authenticates the User 30 to the Computer Network 10. In Step S303, Authentication Event Data 92 is generated. The Authentication Event Data 92 links the network address assigned to the User Computer 30, to the user identification data provided by the user. The Authentication Event Data 92 thus links the network address of the User Computer 30 to the user identification data provided by the User 30. In Step S304 the generation of the Authentication Event Data 92 is sensed. This step can be carried out by the Processor 810 as it executes the Sensor Program 820, as previously explained. In Step S304 the Authentication Event Data 92 is transmitted to the Collector 85 via the Computer Network 10. This step may be carried out on a real-time basis as generation of Authentication Event Data 92 is detected, or it may be performed on a batch basis in which Authentication Event Data 92 are accumulated for a period of time and then transmitted to the collector 85 in one batch transmission, possibly during a period of relatively low usage of the Computer Network 10.

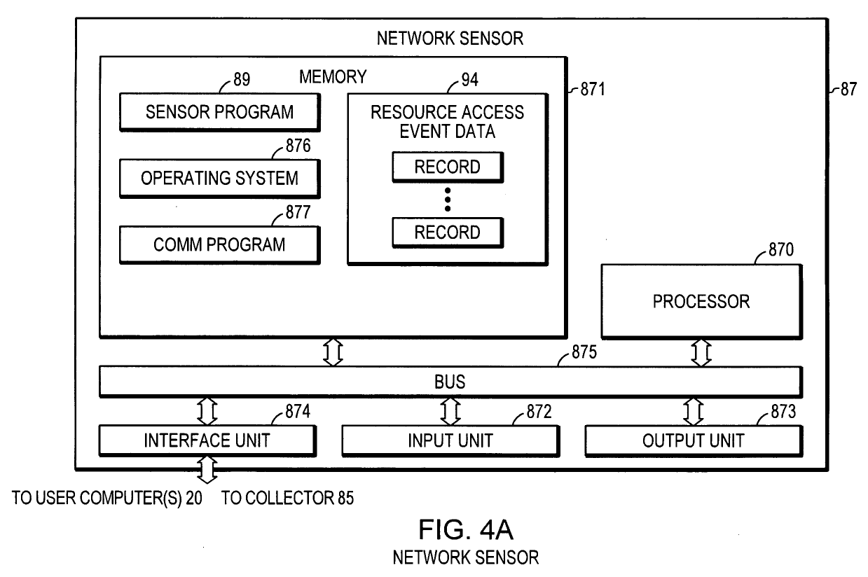

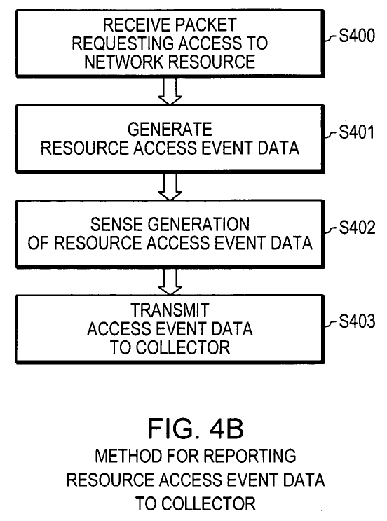

FIG. 4A is an example and embodiment of a Network Sensor Unit 87 connected to sense resource access requests transmitted from User Computer 20 to Application Server(s) 60. Advantageously, the Network Sensor Unit 87 is strategically positioned immediately before the Switch 40 leading to Resource Servers 60. Although FIG. 1 is a simplified Computer Network 10, if needed to detect resource access requests, multiple units such as Network Sensor Unit 87 can be positioned before other Switches to Application Servers in the various physical locations in which these devices reside in the Computer Network 10.

As shown in FIG. 4A, the Network Sensor Unit 87 of this exemplary embodiment comprises a Processor 870, a Memory 871, an Input Unit 872, an Output Unit 873, an Interface Unit 874, and a Bus 875, coupling these elements together. The Processor 870 executes the Sensor Program 89 and the Operating System 876 to sense and store Event Data 94 related to requests by User Computers 20 to access Resources 50 on the Computer Network 10. The Processor 870 further executes the Sensor Program 89 to transmit the Resource Access Event Data 94 to the Collector 85 for storage in the Data Storage Unit 86. The Processor 870 can execute the Communication Program 877 (e.g., a TCP/IP stack) to transmit the Resource Access Event Data 94 to the Collector 85 via the Bus 875 and the Interface Unit 874 (which can be a NIC card or modem, for example). The Input Unit 872 and Output Unit 873 enable a Network Administrator 100 to interact with the Network Sensor Unit 87 to install, configure, and maintain the hardware and software of such unit.

FIG. 4B is a method for reporting Resource Access Event Data 94 to the Collector 85. In Step S400, the Network Sensor Unit 87 receives a packet requesting access to a Network Resource 50. The request packet can be in the form of a synchronization (SYN) packet which identifies the network (e.g., IP) address assigned to the User 30 for a session on the Computer Network 10. In TCP/IP protocol, the SYN packet is the first packet to be transmitted to establish a connection between the User Computer 20 and the Application Server 60. For this reason, in Step S401, the Resource Access Event Data 94 can be generated by the Network Sensor 85 based on the SYN packet requesting access to a Resource 50 hosted by one of the Servers 60. Generation of Resource Access Event Data 94 based on the reception of a SYN packet is advantageous from the standpoint of limiting the amount of data that is collected by the Collector 85 and stored in the Data Storage Unit 86. It only requires the SYN packet to indicate that access to a Resource 50 has been requested. However, this is not to exclude the possibility that additional or all packet traffic detected by the Network Sensor Unit 87 can be collected by the Collector 85 and stored in the Data Storage Unit 86. In Step S402 of FIG. 4B, the Network Sensor Unit 87 executes the Sensor Program 89 to sense that Resource Access Event Data 94 has been generated. This step can be performed on a real-time basis or on a batch basis to transmit Event Data 94 associated with a plurality of user sessions. In Step S403, the sensed Event Data 94 is transmitted by the Network Sensor Unit 87 to the Collector 85 for storage in the Data Storage Unit 86.

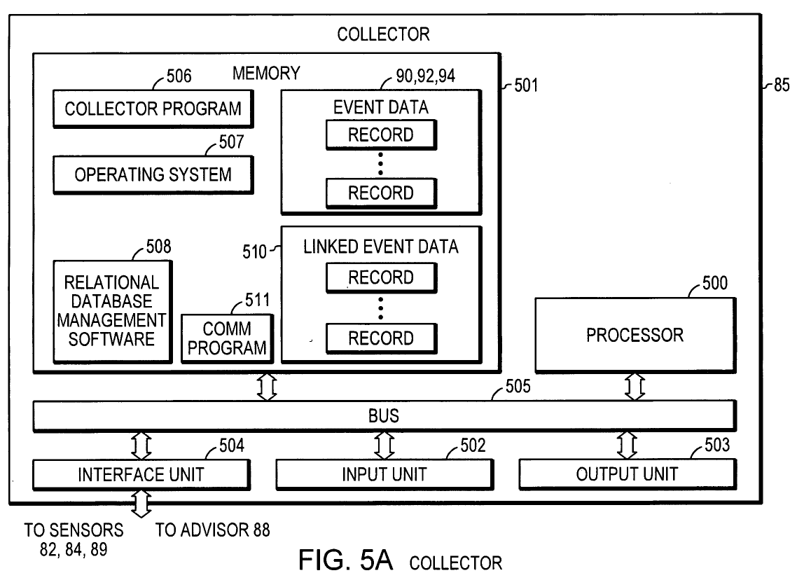

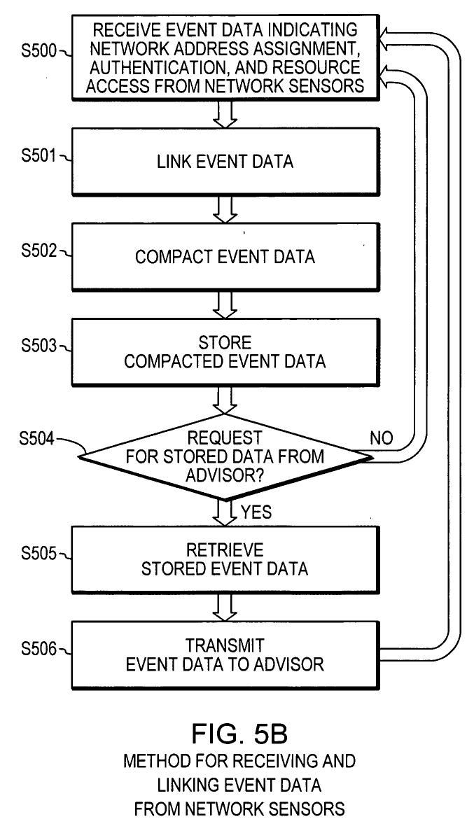

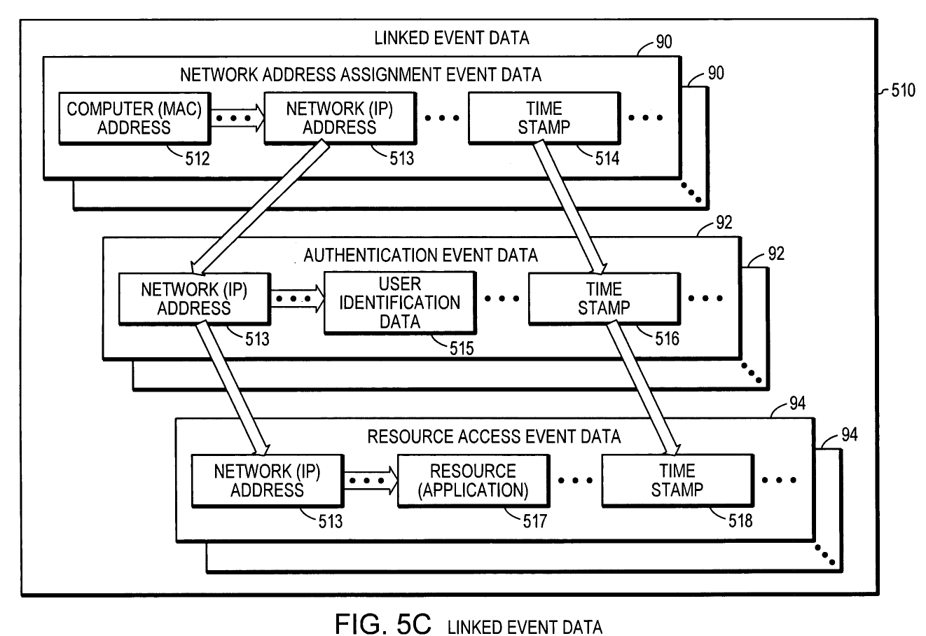

FIG. 5A is an exemplary embodiment of the Collector 85. The Collector 85 comprises the Processor 500, a Memory 501, an Input Unit 502, an Output Unit 503, an Interface Unit 504, and a Bus 505 coupling these elements together. The Processor 500 executes a Collector Program 506 and Operating System 507 in order to perform various functions. More specifically, the Processor 500 executes the Collector Program 506 (which can include well-known Argus software) and the Operating System 507 to receive Event Data 90, 92, 94 from the Network Address Server 81, Directory Server 83, and Network Sensor Unit(s) 87. The Collector 85 further executes the Relational Database Management Software 508 and the Operating System 507 in order to store the Event Data 90, 92, 94 in the Data Storage Unit 86. The Collector 85 can further be configured to link related Event Data 90, 92, 94 by common data elements such as assigned network address and/or time-stamp proximity to generate linked Event Data 510. The Processor 500 can execute the Communication Program 511 (e.g., a TCP/IP stack) to transmit the Event Data 90, 92, 94 and/or linked Event Data 510 to the Data Storage Unit 86 and the Advisor 88. The Collector 85 can transmit such Event Data 90, 92, 94 and/or linked Event Data 510 to the Advisor 88 in response to a request from the Advisor 88 or automatically by execution of its Collector Program 506.

FIG. 5B is a method for receiving and linking Event Data 90, 92, 94 from one or more Network Sensors 82, 84, 89. In Step S500, Event Data 90, 92, 94 indicating assigned network address, authentication, and resource access events, respectively, are received from Network Sensors 82, 84, 89. In Step 501, the Event Data 90, 92, 94 is linked. This can be performed by the Collector 85 by using common data elements in the assignment, authentication and Access Event Data 90, 92, 94, such as the assigned network address, and proximity of time-stamps associated with such Event Data. In Step S502, the linked Event Data 90, 92, 94 can be compacted by eliminating duplicate data elements. In Step S503, the compacted and linked event data can be stored as Data 510 in the Data Storage Unit 86. In Step S504 a determination is made to establish whether the Advisor 88 has requested access to stored data. If not, the Collector repeats Steps S500 through S503 for subsequently received Event Data. Conversely, if the Advisor 88 has requested stored event data from the Collector 85, in Step S505, the Collector retrieves the stored Event Data, and in Step S506, transmits the retrieved Event Data to the Advisor 88 via the Computer Network 10.

FIG. 5C is an exemplary embodiment demonstrating how Event Data 90, 92, 94 can be linked to form linked Event Data 510 by the Collector 85 and/or Advisor 88. The linked Event Data 510 is important from the standpoint that it in effect correlates the User 30, the Computer 20, and the Resource 50 accessed by the User during a session on the Computer Network 10. The capability to link the User 30, User Computer 20, and Resource 50 accessed by such User and Computer enables the Advisor 88 to generate comprehensive presentations for use in compliance and security contexts.

More specifically, referring to FIG. 5C, the user-computer-resource relationship is established as follows. The Network Address Assignment Event 90 indicates the Computer Address 512 of the Computer 20 used by User 30 to initiate a session on the Computer Network 10. The Assignment Event Data 90 links this Computer Address 512 to the Network (e.g., IP) Address 513 assigned to such computer by the Network Address Server 81 for use in the session. The time stamp 514 indicating the time of assignment of the network address to the Computer 20 is also recorded as Assignment Event Data 90. The Assignment Event Data 90 is linked to the Authentication Event Data 92 by the fact that the network address 513 is recorded as Event Data 90, 92 by both the Network Address Server 81 and the Directory Server 83. The Authentication Event Data 92 links the network address 513 to the user identification data (e.g., username or login ID) 515 provided by the User 30 when authenticating to the Computer Network 10. The user identification data 515 can uniquely associate the User 30 with one or more groups as indicated by the Directory Server 83. In addition, the Authentication Event Data 92 has a time stamp 516 and is generated by the Directory Server 83 to indicate the time at which the User was authenticated to the Computer Network 10. This time stamp 516 should be in temporal proximity to the time stamp 514 in normal network usage. For example, in many computer networks, the temporal proximity of the Event Data 90, 92 under normal circumstances is within at most a twenty-four hour period of each other, and in most instances, only seconds or minutes apart. Depending upon what is determined to be normal temporal proximity on a computer network, or how a network administrator chooses to define normal temporal proximity, extraordinary activity can be defined as that occurring outside of the range of temporal proximity determined to be normal on a particular computer network.

The Authentication Event Data 92 is linked to the Resource Access Event Data 94 by the assigned Network Address 513 which is common to both of these Event Data. The network address 13 is linked to Resource (application) Identification Data 517 (e.g., HTTP, FTP, SMTP, etc.) which identifies the Network Resource 50 accessed by the user on the Computer 10. In addition, the Time Stamp 518 is generated by the Network Sensor Unit 87 and stored in the Resource Access Event Data 94 to indicate the time at which the Resource 50 is accessed. In normal network operation, the Time Stamp 518 should have temporal proximity with the time stamps 516 and 514. Else, an unusual network event has occurred, possibly indicating compromise of resource security. The linked Event Data 510 thus relates the Network Event Data 90, 92, 94 so that the Computer 20, User 30, Network Address 513, and Resource 50 are related together. This enables the Adviser 88 to generate a comprehensive view of a series of network events related to access of a resource, including identification of the computer, user, network address, and resource accessed in a series of events.

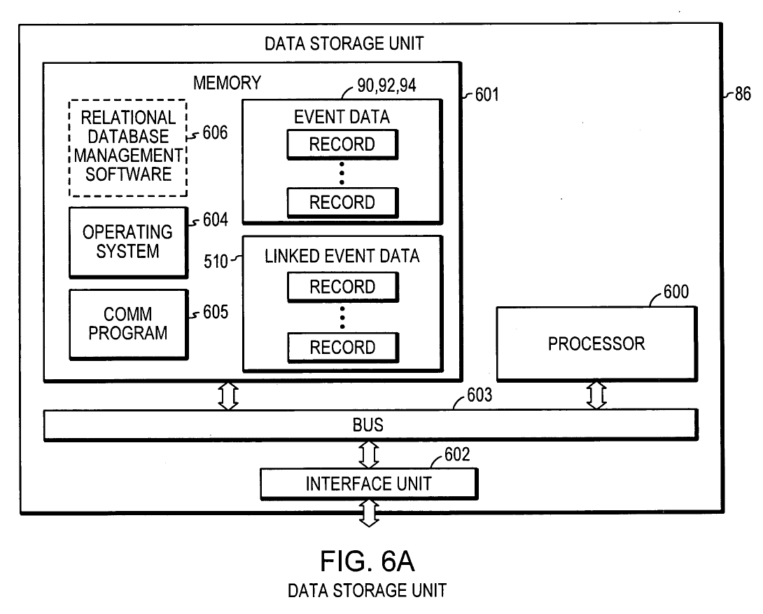

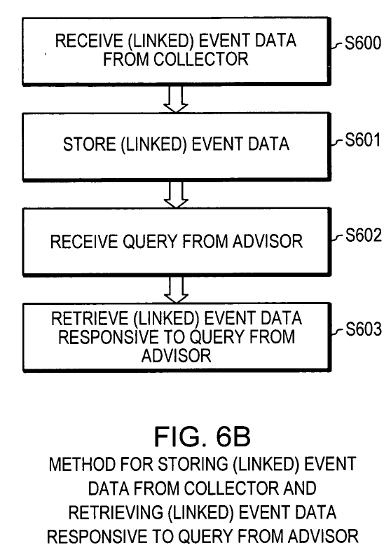

FIG. 6A is an exemplary embodiment of the Data Storage Unit 86 of FIG. 1. The Data Storage Unit 86 comprises a Processor 600, a Memory 601, and an Interface Unit 602, connected by a Bus 603. The Processor 600 executes the Operating System 604, Communication Program 605 and optionally, also Relational Database Management Software 606, to store Event Data 90, 92, 94 and linked Event Data 510 in the Memory 601. The Processor 600 executes the Communication Program 605 to receive Event Data 90, 92, 94 and/or the linked Event Data 510 from the Collector 85 via the Interface Unit 602 (e.g., a NIC card or modem) and the Bus 603. The Processor 600 stores this Event Data 90, 92, 94 and/or the linked Event Data 510 in the Memory 601. In addition, the Processor 600 can execute the Relational Database Management Software 606 to respond to a request from the Advisor 88 and/or the Collector 85 to retrieve and transmit the requested Event Data 90, 92, 94, 510 to the Collector 85 and/or Advisor 88 as appropriate.

FIG. 6B is a method for storing Event Data 90, 92, 94, optionally as linked Event Data 510, received from the Collector 85. It can also be used to retrieve the Event Data 90, 92, 94, optionally in linked form 510, responsive to a query from the Collector 85 and/or Advisor 88. In Step S600, the Data Storage Unit 86 receives the Event Data, optionally in linked form, from the Collector 85. In Step S601, the Data Storage Unit 86 stores the received Event Data in its Memory. In Step S602, the Data Storage Unit 86 receives a query from the Collector 85 and/or Advisor 88. In Step S603, the Data Storage Unit 86 retrieves and provides the Event Data responsive to the query to the Collector 85 and/or the Advisor 88.

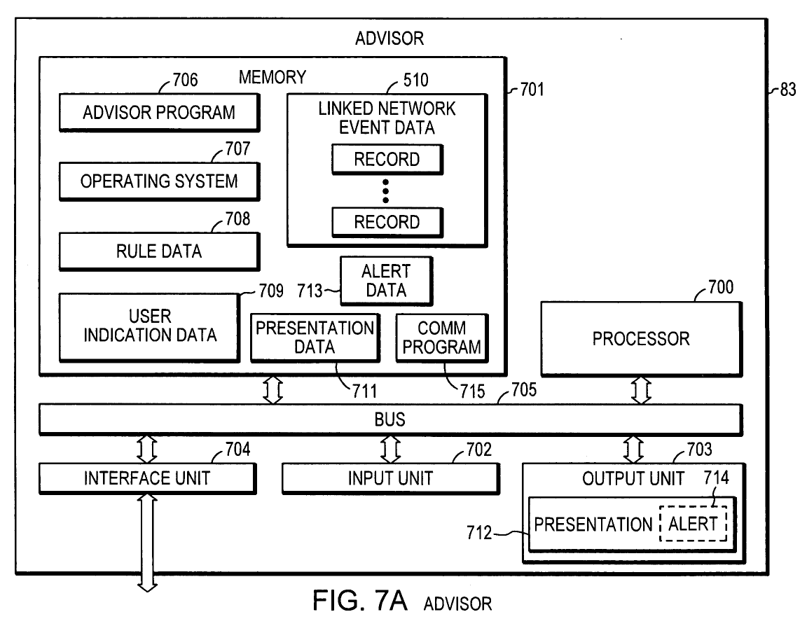

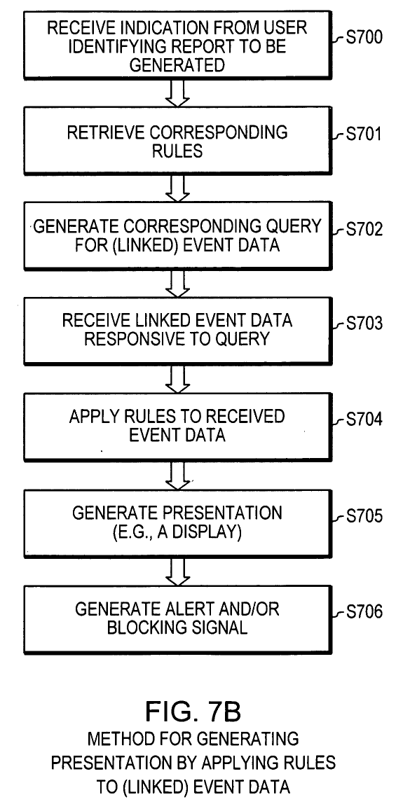

FIG. 7A is an exemplary embodiment of an Advisor 88 of FIG. 1. The Advisor 88 comprises a Processor 700, a Memory 701, an Input Unit 702, an Output Unit 703, an Interface Unit 704, and a Bus 705 connecting these elements together. The Processor 700 executes an Advisor Program 706 and Operating System 707 to perform various functions of the Advisor 701. More specifically, the Processor 700 executes the Advisor Program 706 in conjunction with the Operating System 707 to receive User Indication Data 709 input by a user (e.g., Network Administrator 100) via the Input Unit 702. The User Indication Data 709 indicates a Presentation 712 the user desires to generate based on the network Event Data 90, 92, 94 and/or linked network Event Data 510. In response to receiving the User Indication Data 709, the Processor 700 generates and transmits via the Bus 709 the Presentation Data 712 to the Output Unit 703 which uses the same to generate the Presentation 710. Depending upon the User Indication Data 709, the Presentation Data 711 can be generated based on the Event Data 90, 92, 94 and/or linked form 510 for a variety of purposes. For example, the Presentation Data 711 can be generated by the Processor 700 to ensure that each user session over a period of time specified by the Data 709 includes Assignment Event Data 90, Authentication Event Data 92, and Resource Access Event Data 94. Assuming resource access policies are correctly set by user and/or group, association of the Event Data 90, 92, 94 indicates normal user interaction with Network Resources 50. If one or both of the Assignment Event Data 90 and Authentication Event Data 92 are missing in a user session, it is possible that a rogue on the Computer Network 10 has sought access to a Network Resource 50 which is not permitted by applicable policy, law and/or regulation. Thus, the Advisor 88 can generate the Presentation Data 711 to indicate compliance with applicable network security policy, law and/or regulation in those instances in which user session flow is normal, i.e., Assignment Event Data 90, Authentication Event Data 92, and optionally Resource Access Event Data 94, can be correlated or linked and occur within reasonable temporal proximity in a user session. Thus, the Presentation 712 can be useful for demonstrating compliance with applicable network security policy, law and/or regulation regarding access to Network Resources 50. Alternatively, or in addition to compliance context, the Advisor Program 706 can be such as to generate Data 711 and corresponding Presentation 712 to indicate any instance in which Network Address Assignment Event Data 90 and/or Authentication Event Data 92 are missing from a user session, indicating the possibility of an attack on the network. Furthermore, the Advisor 88 can generate the Presentation 712 in order to indicate possible security vulnerabilities on the network and solutions for solving any security issues that may be so detected. For example, if an Alien Computer 120 appears on the Computer Network 10, the corresponding Event Data 90 (in this case, Event Data indicating a refusal to assign a Network Address issued by the Network Address Server 81) can be the basis to discover and act upon a possible security breach, or alternatively, if a User or Alien Computer 120 is determined by Network Administrator 100 to actually be a User or Computer for which access is permissible, then the Network Administrator can register such User or Computer with the Directory Server 83 so that it will be recognized in subsequent attempts to access the Computer Network 10. As another optional feature of the Advisor Program 706, the Advisor 88 can generate the Presentation 712 on a real time basis so that if any user session indicates the Network Address Assignment Event Data 90, Authentication Event Data 92, and Resource Access Event Data 94 have not occurred within a reasonable time of one another in a user session, then an attack may have occurred or may be underway to access a Network Resource 50. The Advisor Program 706 can be configured to generate alert data 713 and corresponding alert 714 as part of the Presentation 712 provided to a network administrator 100 in the event that an attack is underway on the Computer Network 10. Furthermore, another optional feature of the Advisor Program 706 is to enable same to trigger a response to an attack on the Computer Network 10 detected through missing or irregular Event Data 90, 92, 94. In this optional embodiment, the Advisor 88 signals an enforcement device on the Computer Network 10 to take action to stop an unauthorized attempt to access to a Network Resource 50. For example, the Advisor 88 can trigger the Network Address Server 81 and/or Directory Server 83 to terminate the user session underway, and/or transmit a signal to Switch 40 to block access to the computer address and/or network address used by a rogue or alien computer to attempt access to a Network Resource 50. The above-described functions of the Advisor 88 can be defined by a Network Administrator 100, for example, by setting Rule Data 708 appropriately to generate Presentation 712 and optionally Alert 714 and/or resource access blocking signal. The Processor 700 applies the Rule Data 708 specified by User Indication Data 709, as well as an parameters provided therein (e.g., a time range), and generates the Presentation 712, optionally with Alert 714 and/or blocking signal, based on the Rule Data 708 indicated by the User Indication Data 709. To communicate with other elements of the Computer Network 10, for example, to transmit a blocking signal to prevent a rogue user or alien computer from accessing a Resource 50, the Processor 700 can execute the Communication Program 711 (e.g., a tcp/ip stack) via the Bus 705 and Interface Units 704 (e.g., a NIC card or modem).

FIG. 7B is a method for generating a Presentation 712 on an Output Unit 703 by applying Rule Data 708 to Event Data 90, 92, 94 and/or linked Event Data 510. The method of FIG. 7B can be formed by the Processor 700 as it executes Advisor Program 706, the Operating System 707, and the Communication Program 711. In Step S700, User Indication Data 709 is received from a Network Administrator 100 or other User to identify a Report or Presentation 712 to be generated. The User Indication Data 709 can be received by the User from the Input Unit 702 via Bus 705 and stored by the Processor 700 in the Memory 701. In Step S701, the Processor 700 retrieves any Rule Data 708 for generating the Report Presentation in response to the User Indication Data 708. In Step S702, the Processor 700 generates query for Event Data 90, 92, 94 and/or 510, and in Step S703 receives linked Event Data responsive to the query. The Processor 700 can retrieve the Event Data 90, 92, 94 and/or 510 from the Data Storage Unit 86 via the Computer Network 10, under execution of Communication Program 711. In Step S704, the Processor 700 applies the Rule Data 708 to received Event Data to produce the Presentation Data 711. In Step S705, the Processor 700 generates the Presentation 712 based on the Presentation Data 709. If application of the Rule Data to the Event Data so warrants, the Processor 700 generates an Alert 714 and/or Blocking Signal to an appropriate device on the Computer Network 10 to block a particular User, Computer, and/or Network Address from accessing one or more Resources 50 hosted on the Computer Network 10.

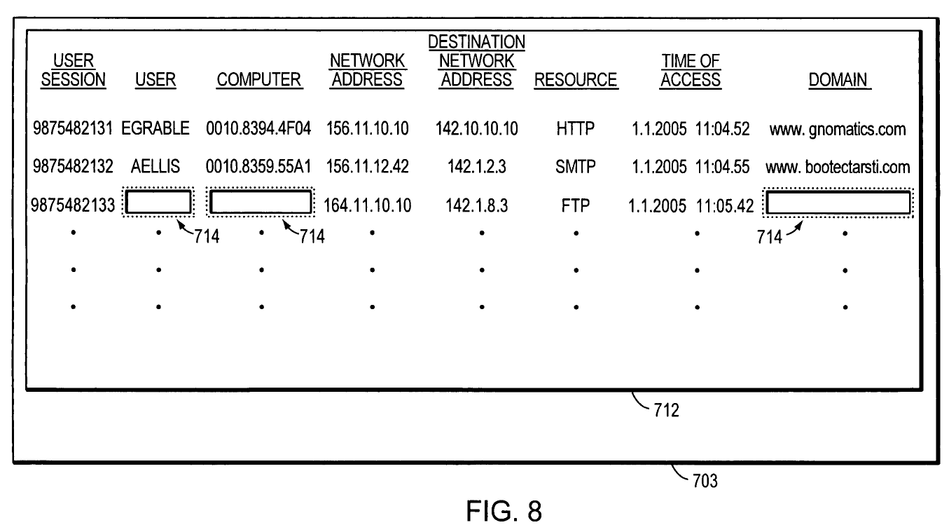

FIG. 8 is an exemplary view of a Presentation 712 that can be generated by the Output Unit 703 of the Advisor 88. As shown in FIG. 8, the Presentation 712 can comprise a list of line item records listing a user session identification number (e.g., ‘9875482131’) uniquely assigned by Server 81 or 83 or Advisor 88 to identify the user session, user identification data (e.g., ‘EGRABLE’) indicating the User 30 authenticated to the Computer Network 10, Computer Address (e.g., ‘0010.8394.4F04’) indicating the physical hardware address or MAC address associated with a network interface card of the User Computer 20, a Network Address (e.g., ‘156.11.10.10’) assigned to the User Computer 20 for use in the session, the Destination Network Address (e.g., 142.10.10.10) of the Resource Server 60 hosting a requested Resource 50, the Resource(s) 50 (e.g., ‘HTTP’) accessed by the User 30 during the session, the time of access of the Resource(s) 50 (e.g., ‘Jan. 1, 2005 11:04:32’), and the domain (e.g., ‘www.argonautics.com’) from which the User Computer 20 has accessed the Computer Network 10. In the third line item for user session ‘9875482133’ the User and Computer are missing, resulting in Alert 714 in the form of a flashing field, sonic alarm, and/or other form of alert to signify that the user session is irregular. In this case, a Resource Access Event Data 94 has been detected without corresponding Network Address Assignment Event Data 90 and Authentication Event Data 92, a circumstance which can indicate that a Rogue User and/or Alien Computer has sought access to a Resource by using a Network Address assigned to another existing user session, for example. Thus, the Network Administrator 100 can be alerted to take action to block access to the Resource 50, or the Advisor 88 can be programmed to automatically do so be generating and transmitting a blocking signal to an appropriate network device to prevent unauthorized access to the Resource(s) 50.

Alternatives

Although the Network Address Server 81 and Directory Server 83 are indicated in FIG. 1 as separate elements, they could instead be implemented on one server along with one or more sensors 82, 84 to report the IP address assignment and authentication Event Data 90, 92 to the Collector 85. Similarly, the Collector 85, Advisor 88 and/or Data Storage Unit 86 can be effectively combined together as one device without departing from the scope of the invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising the steps of:
a) receiving assignment event data from a first device on a computer network, the assignment event data comprising a computer address of a user computer and a network address assigned to the user computer for use in a session on a computer network;
b) receiving authentication event data from a second device on the computer network, the authentication event data indicating the user of the user computer has been authenticated to the computer network for the session and the network address assigned to the user computer used by the user;
c) receiving resource access event data from a third device on the computer network, the resource event data indicating the network address of the user computer and resource accessed by the user computer during the session;
d) linking the assignment event data, authentication event data, and resource access event data using the network address common to such event data;
e) generating presentation data for rendering a presentation, based on the linked assignment event data, authentication event data, and resource access event data; and
f) generating a presentation based on the presentation data.

2. A method as claimed in claim 1 wherein the first device is a dynamic host configuration protocol (DHCP) server that assigns the network address from a pool to the user computer for use during the session.

3. A method as claimed in claim 1 wherein the second device is a directory server storing a directory of user identification data to authenticate the user by checking user identification data provided by the user against the user identification data in the directory to determine whether the user identification data provided by the user is valid.

4. A method as claimed in claim 1 wherein the third device is a network sensor which detects resource access event data.

5. A method as claimed in claim 4 wherein the network sensor extracts at least part of the resource access event data from a packet transmitted by the user computer to a resource server to request access to the resource via the computer network.

6. A method as claimed in claim 1 wherein the steps (a)-(c) are performed by a collector which collects the event data generated by the first, second, and third devices on the computer network.

7. A method as claimed in claim 6 the method further comprising the step of:
g) storing the assignment event, authentication event data, and resource access event data in a data storage unit using the collector.

8. A method as claimed in claim 1 wherein the linking comprises the substep of linking the assignment event data, authentication event data, and resource access event data according to temporal proximity of respective timestamps indicating the times at which such event data were generated.

9. A method as claimed in claim 1 wherein the step (d) is performed by a collector.

10. A method as claimed in claim 9 wherein the collector stores the linked event data in a data storage unit.

11. A method as claimed in claim 1 wherein the step (d) is performed by an advisor.

12. A method as claimed in claim 1 wherein the steps (e)-(f) are performed by an advisor.

13. A method as claimed in claim 12 wherein the advisor performs steps (e) -(f) in response to user indication data indicating a presentation desired by the user to be generated by the advisor.

14. A method as claimed in claim 12 wherein the advisor generates the presentation to indicate assignment event data, authentication event data, and resource access event data linked in the step (d), including the computer address, network address, and user identification data associated with each session.

15. A method as claimed in claim 14 wherein the advisor further generates the presentation to indicate timestamps associated with respective assignment event data, authentication event data, and resource access event data.

16. A method as claimed in claim 12 wherein the advisor generates the presentation to indicate whether any assignment event data and authentication event data are missing from a session, thus indicating a possible attack on the computer network.

17. A method as claimed in claim 16 wherein the advisor generates the presentation on a real-time basis to detect an attack while the attack is still underway.

18. A method as claimed in claim 16 wherein the advisor generates an alert signal to indicate to a network administrator that a session has missing assignment event data and/or authentication even data.

19. A method as claimed in claim 16 wherein the advisor generates an alert signal to advise an enforcement device on the computer network to prevent access to a network resource to a user, computer, and/or network address associated with a session having missing assignment event data and/or authentication even data.

20. A system comprising:
a first server having a network address pool, and configured to assign network addresses to respective user computers for corresponding sessions on a computer network, the first server configured to generate assignment event data indicating the network address assigned to a user computer for use in a respective session on the computer network, and the computer address of the user computer to which the network address was assigned;
a second server having a directory of user identification data, the second server configured to be used to authenticate users by comparing user identification data provided by users, with user identification data stored in the directory, to determine whether the user identification data provided by users are valid, the second server generating authentication event data indicating the network address assigned to a user computer, and the user identification data determined to be valid for the user for a respective session;
at least one network sensor unit coupled in the computer network in proximity to a corresponding network device storing at least one network resource, the network sensor unit detecting requests to access at least one network resource, the network sensor unit generating resource access event data in response to a request to access the network resource from a user computer, the resource access event data comprising the network address assigned to the user computer and data indicating the resource to which access is requested;
a collector coupled to the computer network to receive assignment event data, authentication event data, and resource access event data from the first server, second server, and network sensor unit;
a data storage unit coupled to the collector and storing the assignment event data, authentication event data, and resource access event data received from the collector; and
an advisor coupled to at least one of the collector and data storage unit, the advisor receiving the assignment event data, authentication event data, and resource access event data, and generating a presentation based on the assignment event data, authentication event data, and resource access event data.

21. A system as claimed in claim 20 wherein the first server comprises a dynamic host configuration protocol (DHCP) server which assigns internet protocol (IP) addresses as network addresses.

22. A system as claimed in claim 20 wherein the directory of the second server is part of Active Directory® software.

23. A system as claimed in claim 20 wherein the second server uses lightweight directory access protocol (LDAP).

24. A system as claimed in claim 20 wherein the network sensor detects a transport control protocol (TCP) SYN packet transmitted by the user computer to open a network connection with a resource computer on the computer network, the network sensor extracting at least part of the resource access event data from the SYN packet.

25. A system as claimed in claim 20 wherein the assignment event data, authentication event data, and resource access event data are linked by the collector through the network address common to such event data.

26. A system as claimed in claim 25 wherein the assignment event data, authentication event data, and resource access event data are further linked by temporal proximity of timestamps associated with such event data.

27. A system as claimed in claim 20 wherein the assignment event data, authentication event data, and resource access event data are linked by the advisor through the IP address common to such event data.

28. A system as claimed in claim 27 wherein the assignment event data, authentication event data, and resource access event data are further linked by temporal proximity of timestamps associated with such event data.

29. A system as claimed in claim 20 wherein the advisor generates a presentation indicating assignment event data, authentication data, and resource access event data, including the computer address, user identification data, and network address associated with each session.

30. A system as claimed in claim 29 wherein the advisor generates the presentation by applying rule data corresponding to user indication data identifying the type of presentation a network administrator desires to receive, to the event data received by the advisor.

31. A system as claimed in claim 29 wherein the advisor further generates the presentation to indicate whether any assignment event data and authentication event data are missing from a session, thus indicating a possible attack on the computer network.

32. A system as claimed in claim 29 wherein the advisor generates the presentation on a real-time basis to detect an attack while the attack is still underway.

33. A system as claimed in claim 29 wherein the advisor applies rule data to the event data to determine whether to generate an alert signal in the presentation.

34. A system as claimed in claim 33 wherein the rule data defines one or more of missing network address assignment event data and missing authentication event data for a user session as rules triggering generation of the alert signal.

35. A system as claimed in claim 33 wherein the advisor generates an alert signal to advise an enforcement device on the computer network to prevent access to a network resource for a user, computer and/or network address associated with a session if the session is determined to have missing assignment event data and/or authentication event data.

36. A system as claimed in claim 35 wherein the advisor links the event data and compacts the event data by eliminating redundant data for each session, and generates a presentation including a listing of event data for sessions over a time period.

37. A system as claimed in claim 25 wherein the time period is specified by the user as user indication data input to the advisor to indicate the time period over which the listing is to be generated in the presentation.

38. An apparatus comprising:
a collector configured to receive assignment event data indicating network addresses assigned to respective user computers for sessions on a computer network and the computer address of the user computer, authentication event data indicating the network address of the user computer and user identification data indicating the users of respective user computers, and resource access event data indicating access of network resources by user computers via the computer network, the collector storing the assignment event data, authentication event data, and resource access event data in a data storage unit.

39. An apparatus as claimed in claim 38 wherein the collector is configured to link assignment event data, authentication event data, and resource access event data using the network address common to such event data.

40. An apparatus as claimed in claim 39 wherein the collector is further configured to link the assignment event data, authentication event data, and resource access event data using temporal proximity of timestamp data associated with such event data.

41. An apparatus as claimed in claim 38 wherein the collector is further configured to transmit the event data to an advisor for use in generating a presentation based on such event data.

42. An apparatus as claimed in claim 32 wherein the collector is further configured to compact the event data to eliminate redundant elements for one or more user sessions, and to store the event data in compacted form in the data storage unit.

43. An apparatus comprising:
an advisor configured to receive assignment event data indicating network addresses assigned to respective user computers for sessions on a computer network and the computer address of the user computer, authentication event data indicating the network address of the user computer and user identification data indicating the users of respective user computers, and resource access event data indicating access of network resources by user computers via the computer network, the advisor generating a presentation based on the received assignment event data, authentication event data, and resource access event data.

44. An apparatus as claimed in claim 43 wherein the advisor is configured to link assignment event data, authentication event data, and resource access event data using the network address common to such event data.

45. An apparatus as claimed in claim 44 wherein the advisor is further configured to link the assignment event data, authentication event data, and resource access event data using temporal proximity of timestamp data associated with such event data.

46. An apparatus as claimed in claim 43 wherein the advisor is further configured to generate the presentation to indicate assignment event data, authentication data, and resource access event data, including the network address, computer address, and user identification data.

47. An apparatus as claimed in claim 43 wherein the advisor is further configured to generate the presentation to indicate whether any assignment event data and authentication event data are missing from a session, thus indicating a possible attack on the computer network.

48. An apparatus as claimed in claim 47 wherein the advisor generates the presentation on a real-time basis as the event data are received to detect an attack while the attack is still underway.

49. An apparatus as claimed in claim 47 wherein the advisor generates the presentation to include an alert signal to indicate to a network administrator that an attack is underway.

50. An apparatus as claimed in claim 43 wherein the advisor generates an alert signal to advise an enforcement device on the computer network to prevent access to a network resource for a user, computer and/or IP address associated with a session having missing assignment event data and/or authentication event data.
